(19) United States
(12) Patent Application Publication
(10) Pub. No.: US 2010/0287061 A1
(43) Pub. Date: Nov. 11, 2010

(54) METHOD AND SYSTEM FOR PAYMENT OF A NETWORK-BASED MARKETPLACE TRANSACTION

(76) Inventors: Jeroen Paul Terheggen, Amsterdamn (NL); Robin Johan Schuil, Emmeloord (NL); Bastiaan van den Berg, Amsterdamn (NL)

Correspondence Address: SCHWEGMAN, LUNDBERG & WOESSNER/EBAY, P.O. BOX 2938, MINNEAPOLIS, MN, 55402, US

(21) Appl. No.: 12/535,544

(22) Filed: Aug. 4, 2009

Related U.S. Application Data
(60) Provisional application No. 61/177,188, filed on May 11, 2009.

(51) Int. Cl. G06Q 30/00

(52) U.S. Cl. 705/26

(57) ABSTRACT

A method and a system for payment service integration in a network-based market computer system. For example, an item listing may be created on a market computer system, the item listing being in respect of an item which is offered for sale by a seller. If terms of a transaction in respect of the item listing are agreed upon by a buyer and the seller, the seller being a non-registered user of the market computer system, payment between the buyer and the seller via an electronic payment service may be facilitated at the market computer system. The payment may be subject to buyer protection provided by the electronic payment service.

### CROSS-REFERENCE TO RELATED APPLICATIONS

The present application claims the benefit to United States Provisional Patent Application No. 61/177,188 (“METHOD AND SYSTEM FOR PAYMENT OF A NETWORK-BASED MARKETPLACE TRANSACTION”) filed May 11, 2009, the disclosure of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. All Rights Reserved.

### TECHNICAL FIELD

The present application relates generally to the technical field of online transactions and, in one specific example, to a method and system for facilitating payment by a payment service in a network-based marketplace transaction.

### BACKGROUND

Network-based marketplace systems often require registration of users in order for the users to participate in transactions on the marketplace. Such marketplace systems may include a feedback system in which buyers and sellers are required or encouraged to provide feedback on the other party in transactions, so that a reputation is generated for each user or member. Required registration, optionally in combination with a reputation system, provides prospective participants in a transaction on the marketplace system some indication or assurance as to whether or not the other party to the transaction is a trustworthy actor.

In contrast, some network-based marketplace systems, particularly so-called classifieds marketplace systems on which classified advertisements by prospective sellers are published online, provide a facility for prospective sellers to list items for sale on the marketplace system, while prospective buyers need not be registered users of the marketplace system. Buyers and sellers who are thus placed in contact due to an item listing on the marketplace system typically execute payment of the transaction off-site, outside of the marketplace system.

### BRIEF DESCRIPTION OF DRAWINGS

Some embodiments are illustrated by way of example and not limitation in the figures of the accompanying drawings in which:

FIG. 1 is a block diagram illustrating a system for facilitating transaction payment in a network-based marketplace system, according to an example embodiment.

FIG. 2 is a diagrammatic representation of a market computer system, as may be used in an example embodiment.

FIG. 3 is a flow chart illustrating a method to provide integrated payment service support on a market computer system, according to an example embodiment.

FIG. 4 is a flow chart illustrating a method to create an item listing on a market computer system, according to an example embodiment.

FIG. 5 is a flow chart illustrating a method to communicate buyer interest in an item listing on a market computer system, according to an example embodiment.

FIG. 6 is a flow chart illustrating a method to generate an invoice and to facilitate payment on a market computer system, according to an example embodiment.

FIG. 7 is a flow chart illustrating a method to provide Item Not Received buyer protection for transaction payments on a market computer system, according to an example embodiment.

FIG. 8 is a flow chart illustrating a method to provide Transaction Level Hold buyer protection for transaction payments on a market computer system, according to an example embodiment.

FIGS. 9-20 show respective user interfaces produced during the methods of FIGS. 3-8.

FIG. 21 is a schematic representation of a marketplace application forming part of a market computer system, according to an example embodiment.

FIG. 22 is a schematic representation of a data table structure forming part of a market computer system, according to an example embodiment.

FIG. 23 is a block diagram of a machine in the example form of a computer system within which set instructions, for causing the machine to perform any one or more of the methodologies discussed herein, may be executed.

### DETAILED DESCRIPTION

Example methods and systems for payment service integration in network-based marketplace transactions are described. In the following description, for purposes of explanation, numerous specific details are set forth in order to provide a thorough understanding of example embodiments. It will be evident, however, to one skilled in the art that the present method and system may be practiced without these specific details.

A method and system are provided for facilitating payment in a transaction in a market computer system. A seller may generate or create an item listing on a market computer system which provides a network-based marketplace. The item listing is typically in respect of a particular item which is listed for sale on the market computer system and which is accessible via an extended computer network, such as the Internet. The item listing, when published, includes an indicator which identifies whether or not the particular item listing is supported by an electronic payment service. Payment of transactions in respect of item listings which are supported by the payment service may be effected by a payment service associated with the market computer system, regardless of a registration status of a buyer on the market computer system.

In particular, payment by a buyer who is a non-registered user of the market computer system may be supported by the payment service, and the payment may be subject to buyer protection. With the term “non-registered user” is meant a user for whom there is no user account on the market computer system, or, if the market computer system does have a user account for the user, the user account includes neither reputation information nor a financial or monetary balance for use in an electronic payment. Where payment by the buyer is performed by use of the payment service, buyer protection may be provided by the payment service.

A prospective buyer of the item may contact the seller to express an interest in buying the listed item. In response to this expression of interest by the prospective buyer, the seller may initiate the generation of an electronic invoice message on the market computer system. The electronic invoice message may include a link to the market computer system and, in particular, a link to a transaction page in respect of the item listing. The buyer is prompted on the transaction page to log into the payment service, after which an electronic payment may be processed by the payment service. In an embodiment, activation of the link contained in the electronic invoice message may initiate an uninterrupted payment flow which includes a communication session between a buyer computer and a payment service server during which financial obligations between the buyer and the seller are established. The payment flow may be a series of linked operations, for instance, comprising a series of web pages which include respective links to successive pages in the series. In this manner, payment effected by the payment service server may be integrated in the payment flow managed by the market computer system.

As used herein, the a “communication session between a buyer computer and a payment service server” is intended to include not only, on the one hand, a direct connection between the buyer computer and the payment service server, but also to include, on the other hand, a communication session in which the market computer acts as intermediary between the buyer computer and the payment service server, where there are in fact two communication sessions: one communication session between the buyer computer and the market computer system, and another communication session between the market computer system and the payment service server.

The payment flow may also be comprised of a series of web pages displayed serially on client machine via a web client, or browser, the series of web pages being accessed in a single continuous browsing session.

Payments processed in this manner may include buyer protection afforded by the payment service. The buyer protection may be in the form of a guaranteed financial compensation if the item is not received, or if the item is not significantly as described in the item listing. Instead, or in addition, the buyer protection may be in the form of a process in which the payment is held in escrow until the buyer confirms receipt of the item. In some embodiments, buyer protection may be provided and/or managed by the market computer system.

Integration of an electronic or online payment service in a market computer system on which items are advertised for sale in classified advertisement listings, and where buyers of the items may be non-registered users of the market computer system, is beneficial to a number of parties. A buyer is provided with buyer protection, which would not be the case if payment were to be made through conventional off-site channels, such as a direct transfer or cash payment. Furthermore, the process of completing the payment is significantly simplified from a buyer's perspective, as the buyer, upon receipt of an electronic invoice message, typically in form of an e-mail, need only activate a link contained in the invoice message to be directed to a transaction page pertaining specifically to the listing of the item which is to be bought. Once directed to the relevant transaction page, the buyer need only log in to the payment service and confirm the payment (optionally by selecting appropriate on-screen soft buttons). The sequence of actions constituting a payment flow which a buyer thus has to perform in order to complete the transaction comprises fewer operations and is more convenient than alternative conventional methods. Use of the market computer system as a centralized hub at which item listings are published and through which transactions may be processed permits presentation of integrated information in an invoice message and on a transaction page, thereby enabling convenient access to item listing information for the buyer.

The provision of buyer protection enhances the prospects of the successful sale of items on the network-based marketplace, which is of benefit to sellers.

### Platform Architecture

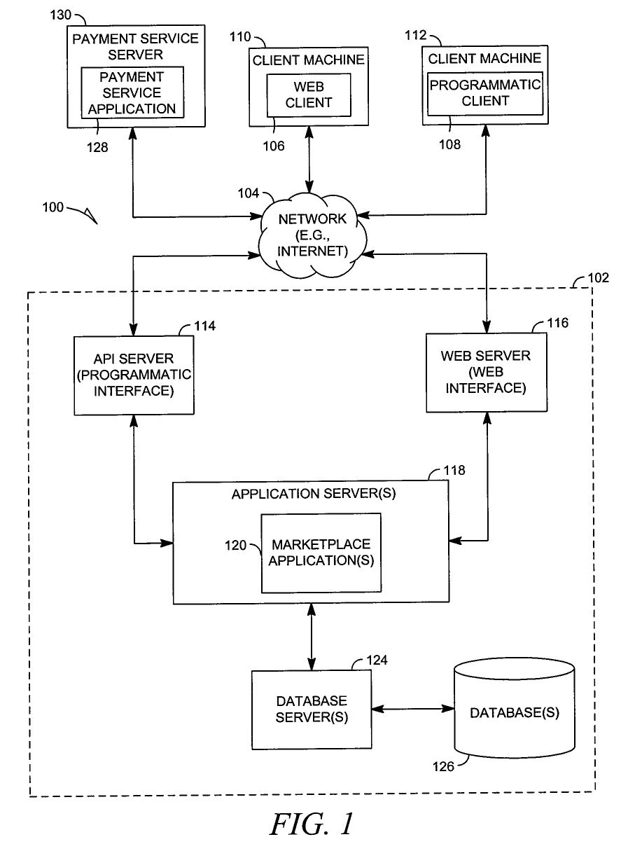

FIG. 1 is a network diagram depicting a client-server system 100, within which one example embodiment may be deployed. A networked system 102, in the example form of a market computer system provides server-side functionality of a network-based marketplace or publication system, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112. For brevity of description, only two client machines 110, 112 are shown, but it will be appreciated that, in use, many client machines 110, 112 may form part of the system 100.

An Application Program Interface (API) server 114 and a web server 116 are coupled to, and provide programmatic and web interfaces respectively to, one or more application servers 118. The application servers 118 host one or more marketplace applications 120. The application servers 118 are, in turn, shown to be coupled to one or more database servers 124 that facilitate access to one or more databases 126. The marketplace applications 120 may provide a number of marketplace functions and services to users that access the networked system 102.

While the system 100 shown in FIG. 1 employs a client-server architecture, other embodiment may of course not limited to such an architecture, and could equally well find application in a distributed, or peer-to-peer, architecture system, for example. The marketplace application 120, as well as any other applications which may be provided by the application servers 118, could also be implemented as standalone software programs, which do not necessarily have networking capabilities.

The web client 106 accesses the marketplace application 120 via the web interface supported by the web server 116. Similarly, the programmatic client 108 accesses the various services and functions provided by the marketplace application 120 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application for providing payment services to the marketplace application 120 in the form of a payment service application 128, executing on a payment service server machine 130. In a particular embodiment, the payment service is provided by PayPal.com™. The payment service application 128 has programmatic access to the networked system 102 via the programmatic interface provided by the API server 114. The system 100 may also include a number of other third party servers that may, utilizing information retrieved from the networked system 102, support one or more features or functions on a website hosted by the third party. The third party website may, for example, provide one or more promotional, marketplace or invoicing functions that are supported by the relevant applications of the networked system 102.

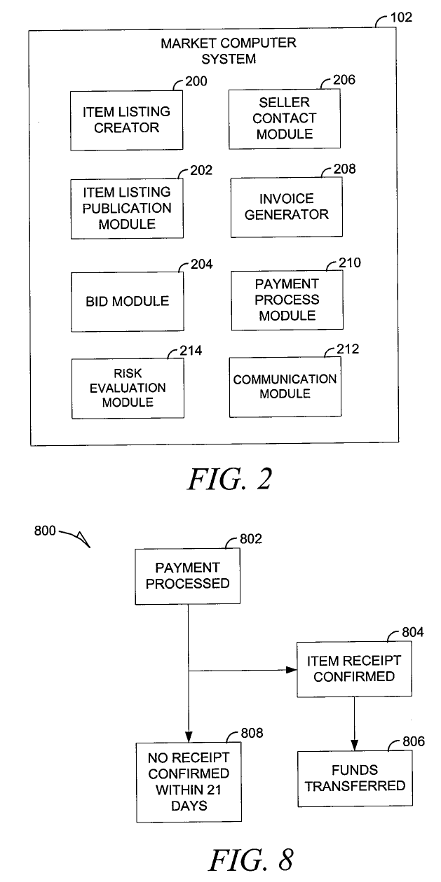

FIG. 2 is a high-level diagrammatic representation of the market computer system 102, showing a number of functional modules forming part of the market computer system 102. The system 102 may include an item listing creator 200 to create item listings in response to seller inputs, as described in greater detail below. An item listing publication module 202 serves to publish item listings, thereby permitting viewing of item listings over the Internet 104 by prospective buyers. Prospective buyers may express interest in item listings by placing bids on the item listings by use of a bid module 204, or by contacting the seller via a seller contact module 206.

The system 102 also includes an invoice generator 208 to generate invoice messages, such as an invoice e-mail, that may include a link to launch a payment flow including user interfaces on web pages relating specifically to the relevant item listing. A payment process module 210 is provided to process or facilitate payment through electronic transfer of funds by the payment service server 130 (FIG. 1) from the buyer to the seller. The system 102 also comprises a communication module 212 to receive user input for item listing creation, invoice generation, and the like. A risk evaluation module 214 is provided to evaluate a risk associated with a proposed transaction, to determine a type, quantum, and/or extent of buyer protection to be offered for the transaction.

### Flowcharts

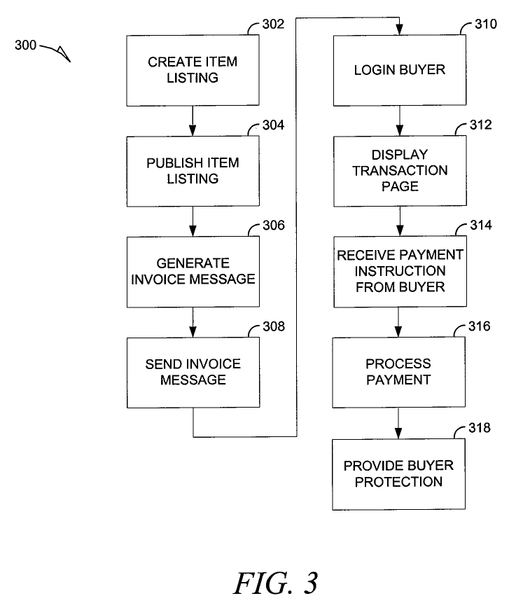

FIG. 3 is a high-level schematic flow chart of a method 300 of facilitating payment in a network-based marketplace, according to one embodiment. The method commences when a prospective seller, who is typically a registered user on the market computer system 102 (FIG. 1), creates an item listing on the market computer system 102, at block 302. The item listing may be in the form of a classified advertisement listing in respect of a particular item which is to be published, at block 304, by the market computer system 102. The item listing may include an indicator that indicates whether or not the item listing is supported by a payment service provided by the payment service application 128 (FIG. 1).

Users are able to access the item listing via the Internet 104. When a prospective buyer is interested in buying the item in the item listing, the buyer may contact the seller to express an interest in the item listing. Contact between the buyer and the seller may be established via the market computer system 102, or the buyer may instead contact the seller by means of an e-mail message or telephonic contact. The buyer may provide the seller with a mail message address, such as an e-mail address, of the prospective buyer.

In response to an expression of interest from the buyer, the seller may then generate an invoice message via the market computer system 102, at block 306. The invoice may be an electronic invoice message in the form of an e-mail message which is sent to the buyer, at operation 308, and which is received and read by the buyer at client machine 110 or 112. The invoice message may include a payment link (e.g. a hyperlink) to the market computer system 102.

Upon receipt of the invoice, the buyer may assess whether or not the proposed transaction is acceptable and, if so, may activate the payment link, for example, by clicking a hyperlink in the invoice message. After activation of the payment link, the buyer is prompted to log in to the payment service application 128, at block 310. If the buyer is successfully logged in to the payment service application 128, a web user interface in the form of a transaction page for the item listing is displayed to the buyer, at block 312. If the proposed transaction is acceptable to the buyer, the buyer instructs payment to be processed, at block 314, optionally by clicking a soft button on the transaction page, as described in more detail blow. Thereafter, payment is processed by the payment service application 128, at block 316, and buyer protection is provided, at block 318.

It is to be appreciated that operations 310 to 316 constitute a payment flow of linked operations, so that a buyer may progress from one operation to the next by activating or clicking links or objects in respective documents or pages in a series. For example, the payment flow may comprise a series of web pages linked by soft buttons or the like, so that the payment flow is initiated by activation of a payment link in the electronic invoice message, and the subsequently displayed web pages form part of a clickstream in a continuous browser session. This payment flow, or clickstream, may include web pages hosted respectively on the market computer system 102 and on the payment service server 130, so that, integrated in the payment flow, may be the establishment of a communication session between the client machine 110 and the payment service server 130 during which financial obligations are established between the buyer and the seller. In some embodiments, the payment flow may be administered by a further third party application optionally interfacing with the marketplace application 120 through the API server 114.

The various operations in the method 300 will now be described in more detail with reference to respective flow charts, and with reference to screenshots illustrating user interfaces generated on client machines 110 or 112.

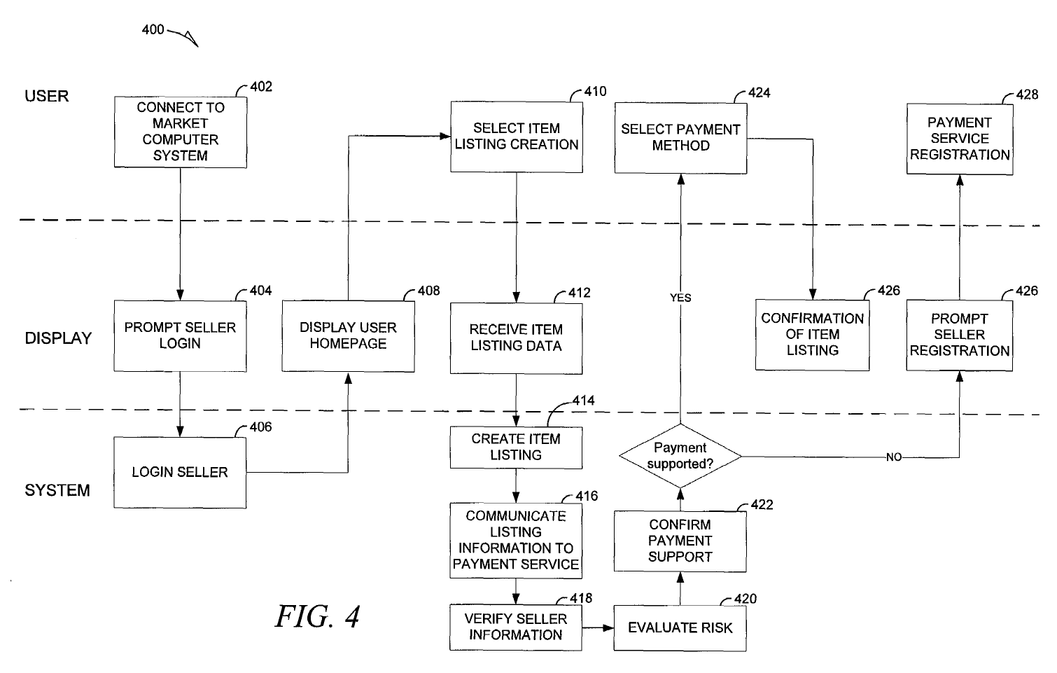

FIG. 4 is a schematic flow diagram, at a lower level, of a method 400 to create an item listing, according to one embodiment. The method 400 commences, at block 402, when a seller accesses the network-based marketplace by establishing communication between the client machine 110 and the market computer system 102 via the Internet 104 (FIG. 1). The seller is then prompted, at block 404, to log in to the marketplace application 120, by entering a username and password. It will be appreciated that the log in prompt will provide users who have not previously been registered with the application 120 to create a user profile, to register, and to log in. The system 102 receives the log-in details, at block 406, verifies the log-in username and password, and logs the seller into the system if the log-in details are verified.

After logging in, a user interface in the form of a user-specific home page is displayed, at block 408. The user-specific home page may include an overview of item listings which are currently published by that particular seller. In the example embodiment, the network based marketplace provided by the market computer system 102 is in respect of classified advertisement listings where sellers list items for publication by the system 102 with a view to private sale of the items to buyers who may identify item listings of interest to them by browsing the online marketplace. If the seller wishes to create a new item listing, a soft button or link on the user specific home page may be selected, at block 410, which launches a first item listing creation page.

In order to initiate creation of an item listing, the seller inputs data, at block 412, into various data fields on the first item listing creation page. The seller first classifies the item that is to be the subject of the listing. It will be appreciated that classified advertisement listings are classified according to the type of article which is offered for sale. In a particular embodiment, the first item listing creation page includes two dropdown menus from which a seller respectively selects an appropriate predefined category or group and sub-group or sub-category. Example categories are Vehicles, Computers and Software, Services, Animals, and so forth, while the sub-categories provide more specific classifications of items in their respective categories. In an example embodiment, the first item listing creation page also provides a radio button selection to specify whether the item listing which is to be created is in respect of an item which is listed for sale, or whether the seller wishes to place an advertisement seeking a particular item. The seller is further prompted to enter a contact e-mail address on the first item listing creation page.

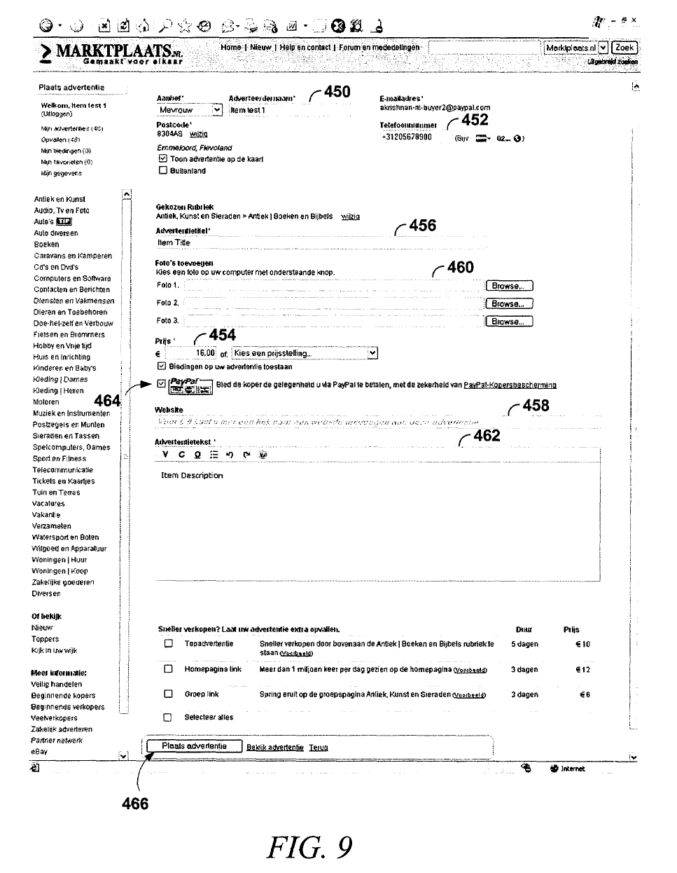

The seller may then progress to a second item listing creation page, an example of which is shown in FIG. 9. The seller may input the seller name to be displayed in box 450, a contact telephone number in box 452, an offer price in box 454, a title for the item listing in box 456, a website URL which may be displayed with the item listing in box 458, one or more images illustrating the item in boxes 460, and free text to form part of the item listing in box 462. Additionally, the second item listing creation page includes a data field or input field for permitting the seller to elect whether or not the item listing is to be supported by the payment service 130. In an example embodiment, the second item listing creation page includes a check box or tick box 464 which the seller can optionally tick to provide payment support input, indicating that the item listing is to be supported by the payment service 130. If all of the item listing information has been completed, the seller may select or press soft button 466 to proceed.

Returning to FIG. 4, the market computer system 102 thereafter creates the item listing, at block 414, providing it with a unique identification number and linking it to the seller. The market computer system 102 then sends data about the item listing to the payment service application 128 via the API server 114 (FIG. 1), at block 416. The payment service application 128 checks, at block 418, if the seller's e-mail address associated with the item listing is an e-mail address previously registered on the payment service application 128.

The method 400 may include evaluating risk associated with a particular transaction, and providing buyer protection based on the evaluated risk. Such risk evaluation may be performed with reference to various risk factors. In the example embodiment of FIG. 4, one of the risk factors is the classification of the item listing. As described above, each item listing is classified in a particular category and sub-category. The market computer system 102 may thus evaluate the risk with reference to a pre-determined list of eligible categories and/or sub-categories for which buyer protection is provided. Thus, the method 400 may include, at block 420, assessing whether or not the item listing is classified in an eligible category and/or sub-category. If the item listing is in an eligible class, buyer protection is provided for the item listing. If, however, the item listing is not in an eligible class, the item listing may still supported by the payment service application 128 so that payment from a buyer can be processed by the payment service application, but no buyer protection is provided. Other factors that may be considered in assessing whether or not buyer protection is provided, and/or the quantum, type or extent of buyer protection to provide, may include the advertised selling price in the item listing, the geographic location of the buyer and/or the seller, and the like.

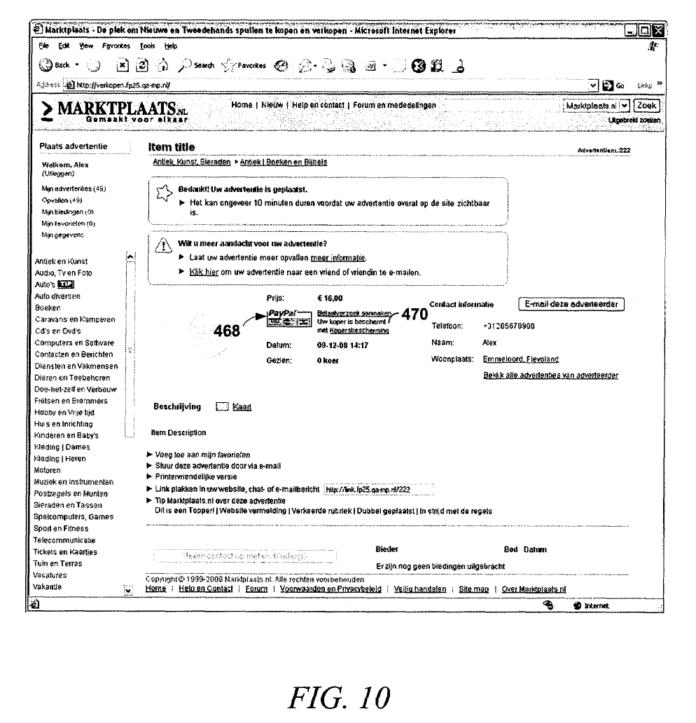

At block 422, the payment service application 128 provides the market computer system 102 with confirmation data regarding the item listing, including a flag indicative of whether or not the item listing is supported by the payment service application 128. In the example embodiment of FIG. 4, only item listings for which the seller information could not be verified, at block 418, will be flagged as unsupported by the payment service application. If the item listing is flagged by the payment service application 128 as being supported by the payment service, a payment option page is displayed to the seller, prompting the seller to select a payment option which is preferred by the seller for publication of the item listing, at block 424. After payment is completed, the process of creating the item listing is complete, and a confirmation page is displayed to the seller, at block 426. An example confirmation page is shown in FIG. 10, and includes an indication 468 that the item listing is supported by the payment service and includes an indication 470 of buyer protection, if the item listing is indeed subject to buyer protection.

Returning to FIG. 4, if the item listing is flagged by the payment service application 128 as not being supported (for instance, because the seller is not a registered user with the payment service or the entered e-mail address is not a registered e-mail address) a notification may be posted, at block 428. The notification may prompt the user to provide a valid e-mail address or to register with the payment service application 128, at block 426.

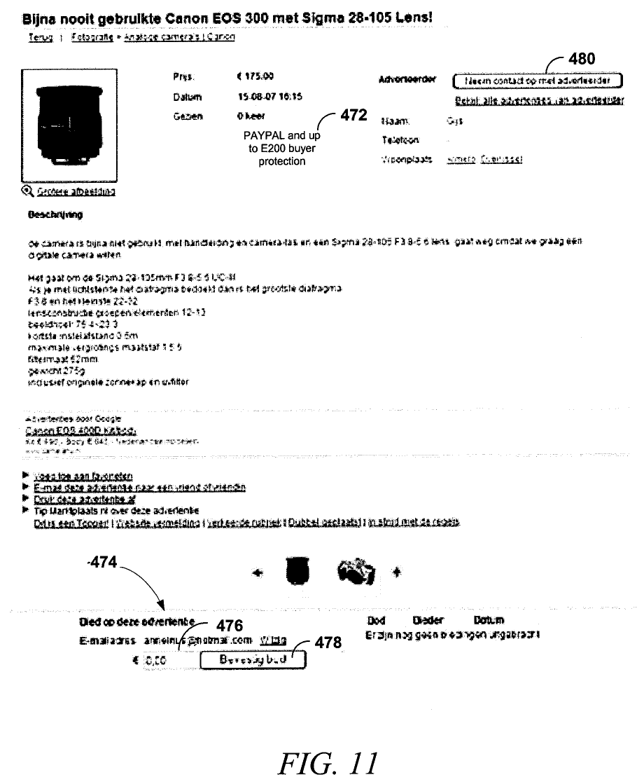

After creation of the item listing, as described with reference to FIG. 4, the item listing is published by the marketplace application 120 for viewing by prospective buyers. An example classified advertisement listing or item listing is shown in FIG. 11. The item listing includes an indicator 472 which identifies the item listing as being provided with buyer protection. In the illustrated example, the indicator is in the form of text stipulating that buyer protection of up to [symbol] 200 is provided for the item listing. In other embodiments, the indicator may be in the form of an icon or device indicative of buyer protection and the payment service.

The published item listing may include a graphical user interface (GUI) which provides bid facility 474 to permit the buyer to register a bid on the item listing. In the example embodiment of FIG. 11, the bid facility 474 comprises a text entry box 476 for receiving the quantity of a bid which is to be posted, as well as a soft button 478 to confirm the bid. The published item listing includes contact details of the seller, enabling a buyer to contact the seller. The contact details of the seller may include a telephone number and e-mail address of the seller. The published item listing may farther include a contact facility to enable a prospective buyer to contact the seller. In the example embodiment of FIG. 11, the contact facility is a soft button 480 which launches a message page presenting a GUI for the population of an electronic message, in particular an e-mail message, from the buyer to the seller.

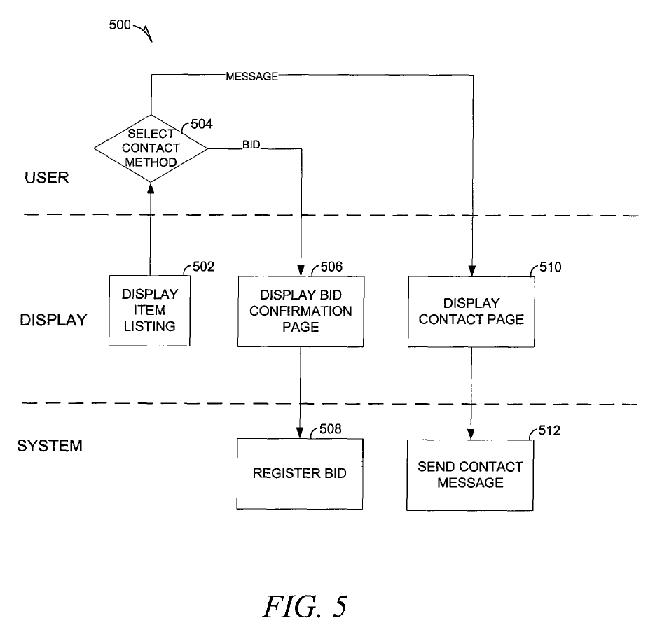

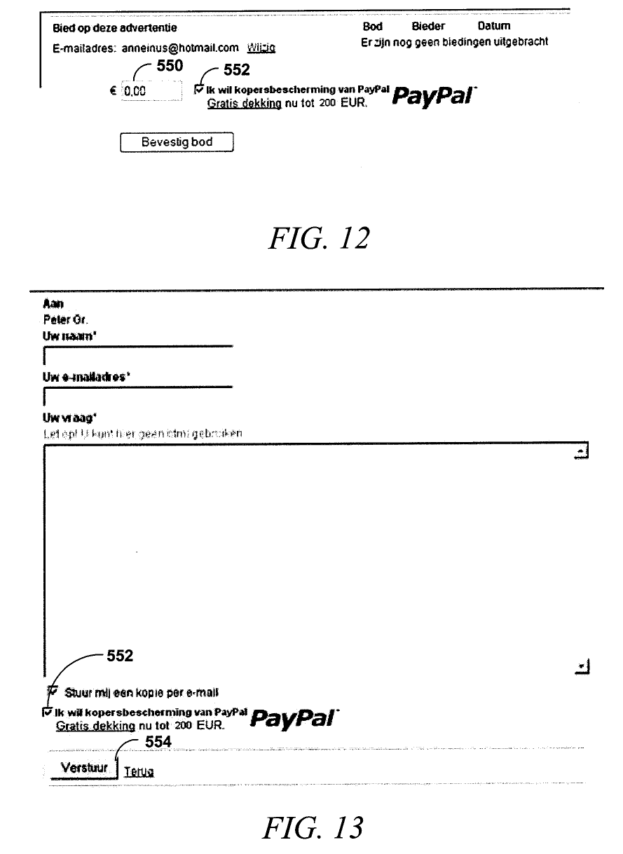

An example method 500 of providing notification of buyer interest to a seller is described with reference to FIG. 5. Upon viewing the published item listing, at block 502, the seller may elect, at block 504, to place a bid via the bid facility 474 (FIG. 11), or to contact the seller via the contact facility 480 (FIG. 11). It is to be noted that the buyer has the option of contacting the seller off-site (for instance, by way of telephone or by a separately generated e-mail). If the user elects to express interest in the item listing via the bid facility 480, a bid confirmation page is launched, at block 506, an example of which is shown in FIG. 12. The bid confirmation page includes a text box 550 for receiving a bid amount and also includes a tick box or check box 552 for receiving input from the buyer to indicate whether or not buyer protection is desired.

Upon confirming the bid, the bid is processed by the marketplace application 120 (FIG. 1), at block 508, so that the bid is displayed to the seller when the seller views the item listing. In other embodiments, an e-mail may automatically be sent to the seller to alert the seller of the entered bid.

If, instead, the buyer elects to contact the seller via the contact facility 480, a contact page is launched, at block 510, an example embodiment of which is shown in FIG. 13. The contact page provides a GUI for receiving the name, e-mail address and message text from the buyer. Additionally, the contact page includes an input field in the form of a tick box or check box 552 for receiving input from the buyer regarding whether or not payment of the proposed transaction is to be subject to buyer protection. Selecting a soft send button 554 results in sending of the message to the seller, at block 512.

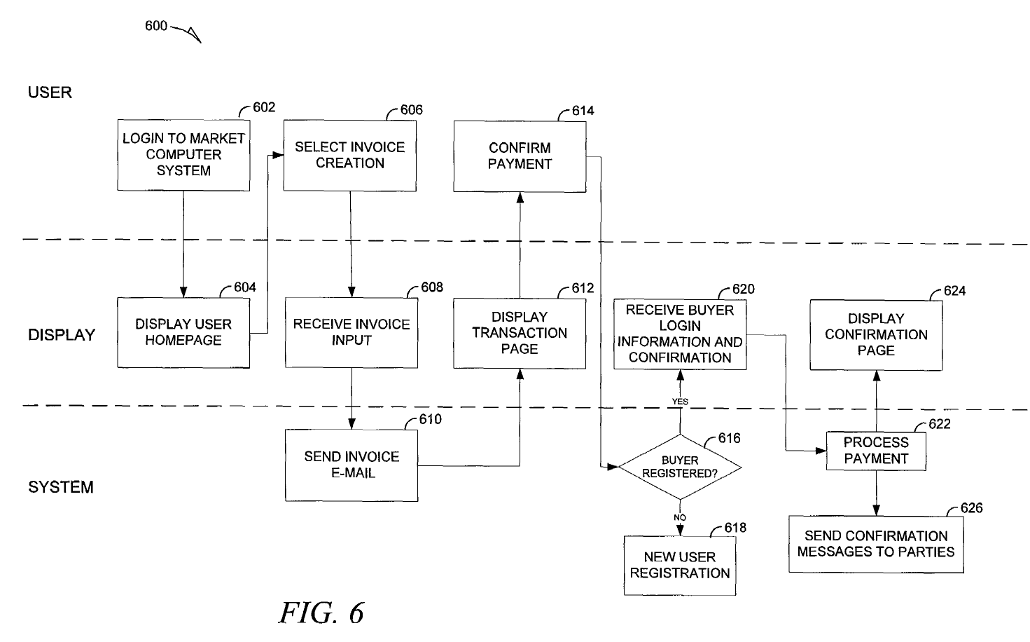

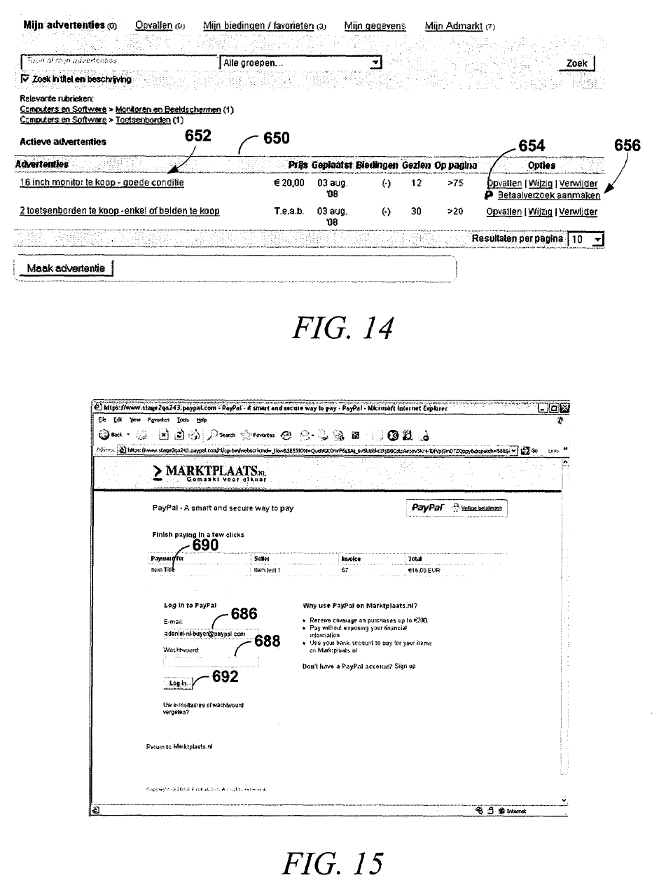

The flowchart of FIG. 6 shows an example method 600 of generating an invoice and facilitating payment by the payment service application 128 (FIG. 1). After logging on to the marketplace application 120, at block 602, in conventional fashion, a seller's homepage user interface is displayed, at block 604, which may provide an overview of all item listings listed by the seller. In FIG. 14, box 650 shows an extract of such an overview or home page, showing two item listings 652. It will be noted that one of the item listings 652 includes an indicator 654, which indicates that the item listing 652 is supported by the payment service application 128. The seller can also view a particular item listing on a separate listing page, which also includes a visual device or icon as indicator that the item listing 652 is supported by the payment service application 128. The item listing page may also include text which indicates whether or not buyer protection is provided on the item listing. Both the overview box 650 and the item listing page include an object to launch invoice generation, the object in this example being in the form of a hyperlink 656.

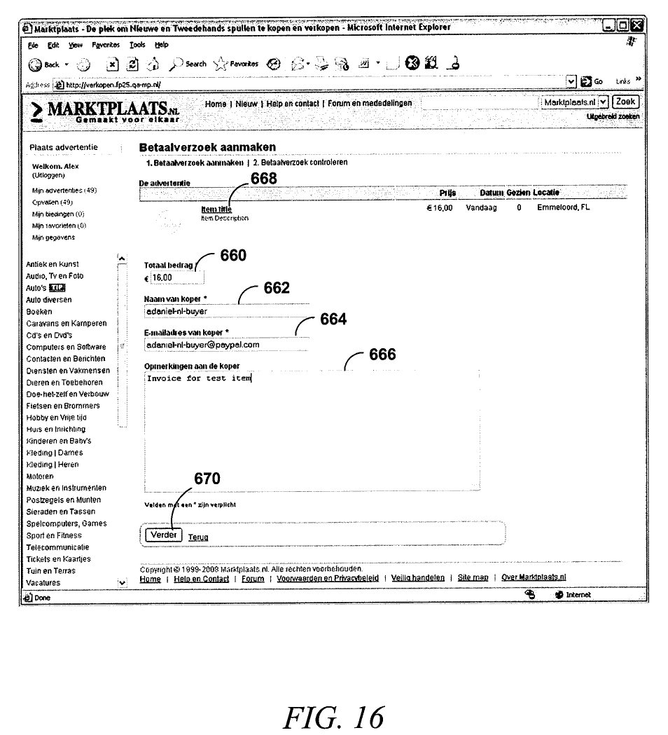

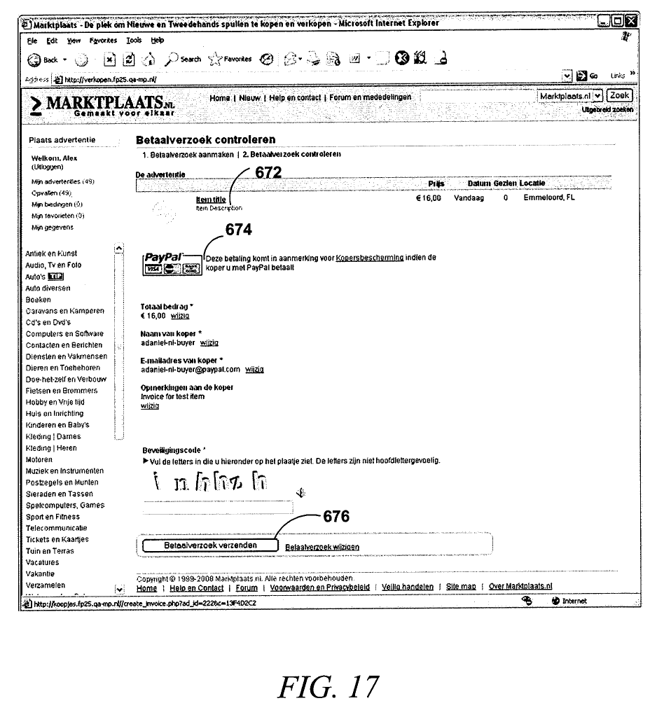

Upon selecting or clicking the hyperlink 656, at block 606, the invoice generator 208 (FIG. 2) launches an invoice generation page, an example embodiment of which is shown in FIG. 16. The invoice generation page includes text boxes for receiving a selling price 660, a buyer name 662, an e-mail address for the buyer 664, and free text remarks 666. The invoice generation page also includes a hyperlink 668, which permits the seller to view details of the item listing, should the seller wish to review the item listing information. After completing input of the data into the text boxes, at block 606, the seller selects a “proceed” soft button 670, which causes the launch of an invoice confirmation page (FIG. 17). The invoice confirmation page summarizes the item listing information and again provides a hyperlink 672 to review the item listing in greater detail, and also includes a visual indicator 674 that the item listing is supported by the payment service application 128. If the seller is satisfied with the displayed invoice information, a “send” soft button 676 is selected, upon which an electronic invoice message, in the example form of an e-mail message, is generated and sent to the buyer's e-mail address, at block 610.

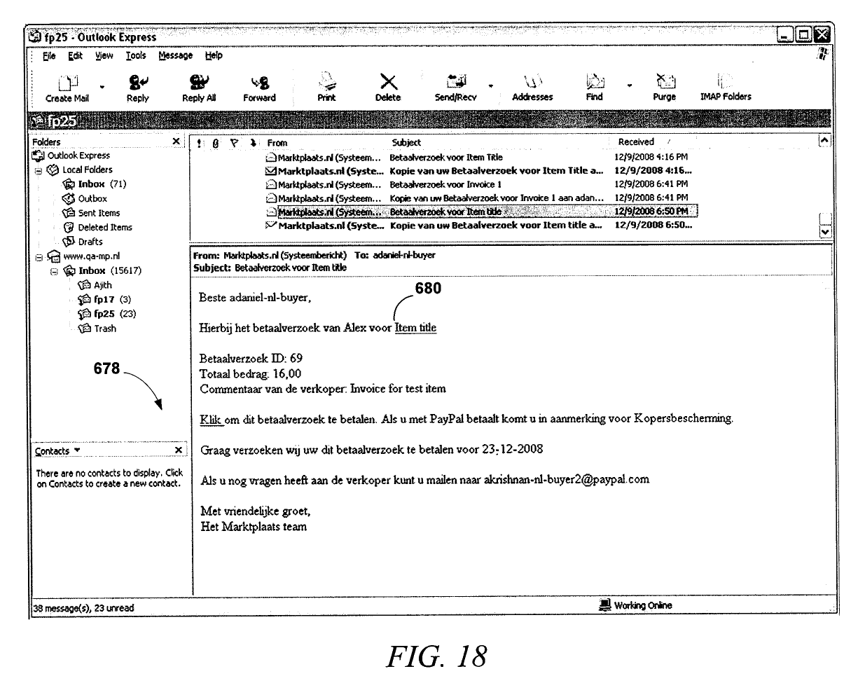

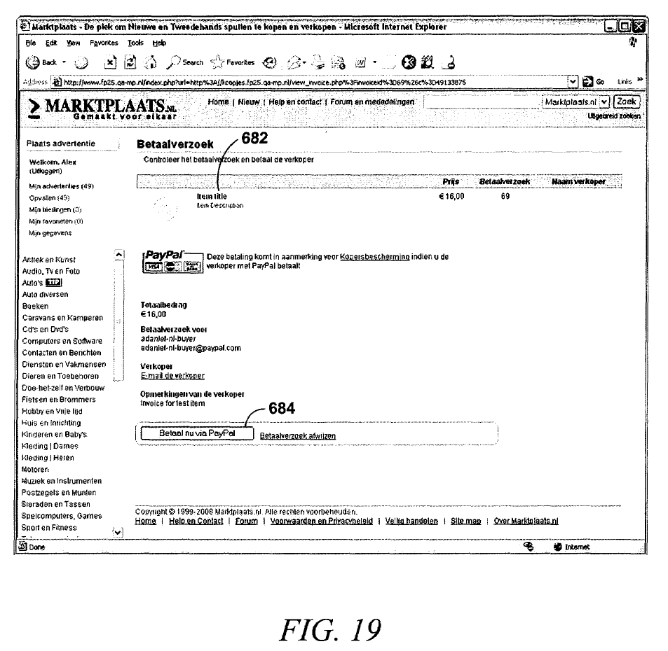

An example embodiment of an invoice e-mail sent to the buyer is shown in FIG. 18. The invoice e-mail comprises text setting out the details of the proposed transactions, and also includes a link to launch an integrated payment flow executed by the marketplace application 120 and the payment service application 128, which are in communication via the API server 114 (FIG. 1). In the example embodiment of FIG. 18, the link is a hyperlink 678 stating “Click to pay this invoice.” When a buyer, using a client machine 110 (FIG. 1), clicks on the hyperlink 678, the web client 106 launches, at block 612, a transaction page on the marketplace application 120, an example of which is shown in FIG. 19. The invoice also includes a hyperlink 680 to display further details of the item listing, including any images that were published with the item listing. A buyer who receives an invoice but who is unsure as to the subject of the invoice can conveniently click on the item listing hyperlink 680 to launch a web page displaying the relevant information.

Likewise, the transaction page has a link 682 to enable viewing of the item listing details before confirmation of the payment. It will be noted that the transaction page is pre-populated with transaction details, in particular the payment amount, based on data inputted by the seller, at block 608. If the buyer wishes to proceed with payment of the invoice, a “pay now” soft button 684 on the transaction page is selected, at block 614.

Upon selection or clicking of the “pay now” button, it is determined, at block 616, whether or not the buyer is a registered user, or member, of the payment service application 128. This determination is based on the buyer's e-mail address as entered in the invoice e-mail. If it is determined that the buyer is not a registered user of the payment service application, then a sign up or registration flow is launched, at block 618, through which the buyer can sign up or register with the payment service application 128. If, on the other hand, it is determined that the user is registered with the payment service application 128, a payment service log in page is launched, at block 620. In other embodiments, a database check may be performed on the buyer e-mail address, to verify a user history on a variety of online services. Such a database check may be used in risk evaluation where the buyer protection afforded varies depending on the evaluated risk. An example log in interface is shown in FIG. 15, comprising a pre-populated buyer e-mail text box 686 and a password text box 688 for receiving a buyer password. Again, the user log in interface includes information pertaining to the item listing, and may include a hyperlink 690 to the item listing. In some embodiments, buyer protection may be determined based on the geographic location of the buyer, with buyer protection, for example, being provided only to buyers residing in a particular country or region.

Selection of a ‘log in’ soft button 692 on the log in interface after population of the password text box 688 triggers verification of the password, and, if verified, results in execution of payment by the payment service application, at block 622. Other embodiments may include an additional intermediary user interface or web page, giving the buyer a final opportunity to confirm transfer of the payment before the payment is effected. Payment may be effected by transferring funds electronically from a buyer's account to a seller's account via the payment service application 128. After successful payment, a payment confirmation page is displayed, at block 624. In addition, e-mails may be sent, at block 626, to both the buyer and the seller, to advise the respective parties of the payment details. These confirmation e-mails may include respective hyperlinks to the item listing on the market computer system 102, so that a recipient of one of the e-mails can conveniently be apprised of the relevant item listing by clicking the hyperlink.

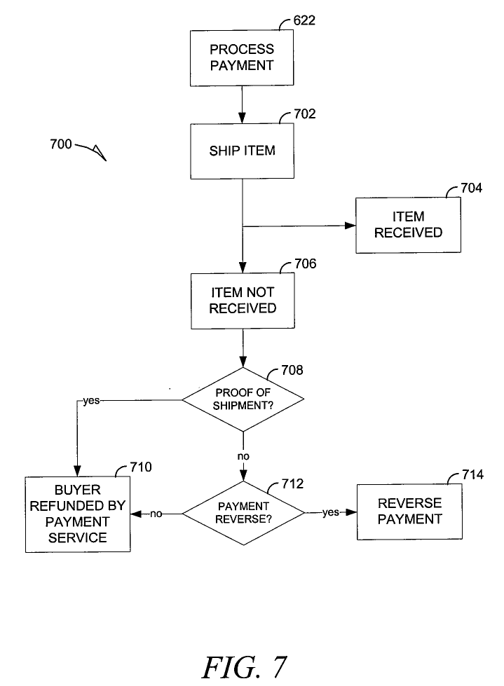

Buyer protection may take different forms in different embodiments, or may vary depending on the evaluated risk of a particular payment. The buyer may, for example, be protected for non-receipt of the item, also referred to as Item Not Received (INR) protection. The INR protection may be capped at a maximum amount, so that a buyer is fully reimbursed for items where the payment is smaller than the maximum amount, while the buyer may be reimbursed only the maximum amount in instances where the payment is greater than the maximum amount. In other embodiments, the INR protection may be uncapped. In FIG. 7, flowchart 700 shows an example embodiment of INR buyer protection.

After processing of payment, at block 622, the seller ships the item to the buyer, at block 702. If the item is received, at block 704, no INR buyer protection is required. If, however, the item is not received, block 706, it is established, at block 708, whether or not the seller can provide proof of shipment. If proof of shipment is provided, it is assumed that the item went astray in the shipping process. The seller thus retains the transferred payment, and the buyer is refunded by the payment service application 128, at block 710, for the cost of the payment, up to the maximum amount. If, however, the seller does not provide proof of shipment, it is established, at block 712, whether or not the payment can be reversed. If the payment can be reversed, a reverse transaction is performed by the payment service application 128, at block 714, so that the buyer is fully refunded at the expense of the seller. If, however, the payment cannot be reversed, for instance due to bankruptcy, lack of funds, and the like, of the seller, the payment service application 128 refunds the buyer, at block 710, up to the maximum amount.

The buyer protection may, in other embodiments, include Significantly Not As Described (SNAD) protection. In such a case, the buyer can file a SNAD if the item which is received is not significantly as described in the item listing. The dispute may be resolved by the payment service, and may include return of the item from the buyer to the seller and reversal of payment, may comprise payment of a refund by the payment service, or may comprise an agreement of partial compensation between the buyer and the seller.

A further form of buyer protection that may be provided is a Transaction Level Hold (TLH) in terms of which the payment is held in escrow until the buyer confirms receipt of the item or until expiry of a set period, whichever happens first. In FIG. 8, flowchart 800 shows an example embodiment of a TLH process. After confirmation of payment by the buyer, at block 802, the funds are not electronically transferred into the seller's account, but are instead retained, so that the payment is put on hold. When the buyer receives the item, which may have been shipped to a buyer's address, the buyer may confirm receipt, at block 804. In response to receiving confirmation of receipt, the transaction level hold on the payment may be released, so that the funds are transferred to the seller's account, at block 806. If, however, no confirmation of receipt is received from the buyer within a set period after confirmation of payment, at block 808, it is assumed that the item has been received, and the payment is completed, at block 806. In the example embodiment, the predetermined period, after which receipt of the item is assumed, is 21 days.

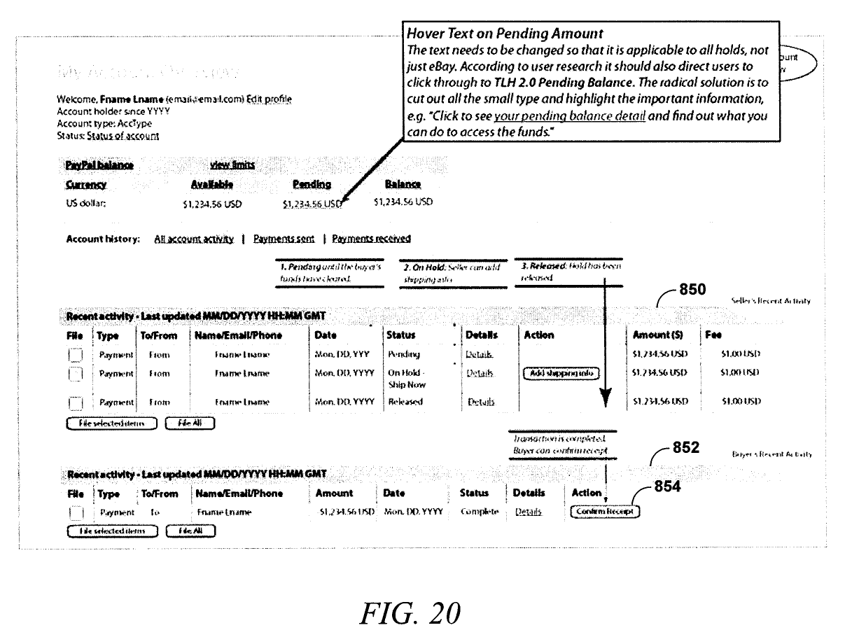

To allow convenient transfer confirmation of receipt by the buyer, an account interface may include an object to trigger confirmation of receipt. FIG. 20 shows an example account interface for the seller, at box 850, and a buyer's account interface 852. In this example embodiment, the buyer's account interface 852 includes a “Confirm Receipt” soft button 854 forming part of a line item for the item listing in a recent activity list. Clicking on the soft button 854 results in registration of the item as having been received. Additionally, an object similar to the “Confirm Receipt” soft button 854 may be provided on an item listing overview page on the marketplace application 120 (FIG. 1), as well as on a web page relating specifically for the item listing. Pressing the “Confirm Receipt” soft button 854 communicates receipt of the item to the payment service application 128, resulting in release of the payment.

Box 850 shows activity history for the seller's account, showing respectively that the payment was on hold, awaiting confirmation of receipt from the buyer, and was thereafter released.

Facilitation of payment by the market computer system 102, in instances where the buyer is a non-registered user of the market computer system 102, results in the technical advantage of an integrated payment flow. Such an integrated payment flow permits the buyer convenient access to item listing information during a payment process. For example, in the embodiment described with reference to FIG. 19, a web page displayed to the buyer includes a link 682 to item listing information, thereby allowing the buyer, e.g., to ensure that the payment is in respect of the correct item listing.

The establishment of a communication session between a buyer computer 110 and the payment service server 130 has the advantage of an integrated, seamless payment flow presented to the buyer computer 110, displaying to the buyer, as part of the integrated payment flow, web pages hosted on the market computer system 102 as well as web pages hosted on the payment service server 130. In one embodiment, the establishment of a communication session between the buyer computer 110 and the payment service server 130 is achieved by establishing one communication session between the buyer computer 110 and the market computer system 102, and establishing another communication session between the market computer system 102 and the payment service server 130, so that the market computer system 102 acts as intermediary in an effective communication session between the buyer computer 110 and the payment service server 130.

An advantage of integration between the market computer system and the payment service server 130 is that it facilitates the provision of buyer protection with respect to transactions on a market computer system 130 where the buyer is a non-registered user of the market computer system 130. For example, information contained in the item listing published by the market computer system 102 may be used in assessing a Significantly Not As Described buyer protection claim, as described above.

Yet a further advantage is the provision of an invoice generator, such as the invoice generator 208 of FIG. 2, to generate an electronic invoice (FIG. 18). The invoice generator 208 automatically populates information about the item listing in the electronic invoice, saving a seller from manual insertion of the automatically inserted information. Furthermore, the electronic invoice may include a link to item listing information, so that a buyer receiving the invoice can access item listing information by activation of the link instead of having to launch a separate browser session, navigate to a web site associated with the marketplace computer system 130, and search for the particular item listing. Additionally, the electronic invoice includes an active link to launch an integrated payment flow with respect to the particular item listing. Because user information about the seller is hosted on the market computer system 102, and due to information exchange between the payment service server 130 and the market computer system 130, recipient information may be automatically provided by the payment service server 130. In other words, when a payment web page hosted by the payment service server 130 is displayed to the seller as part of the integrated payment flow, recipient details, such as a name or account of seller, may be pre-populated on the payment web page.

### Marketplace Applications

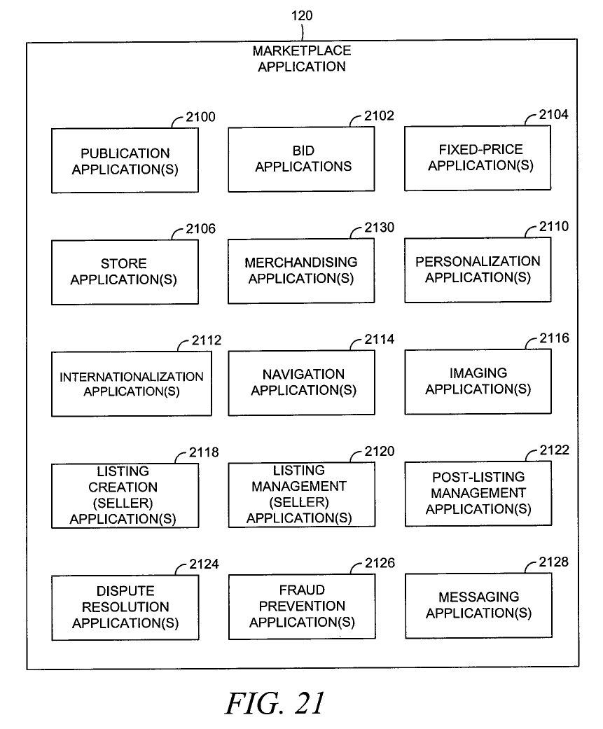

FIG. 21 is a block diagram illustrating multiple applications or modules which may form part of the marketplace application 120 that, in one example embodiment, is provided as part of the networked system 102. The application may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 2100 and one or more bid applications 2102. A number of fixed-price applications 2104 support fixed-price listing formats (e.g., the traditional classified advertisement-type listing or a catalogue listing).

Store applications 2106 allow a seller to group listings within a “virtual” store, which may be branded and otherwise personalized by and for the seller. Such a virtual store may also offer promotions, incentives and features that are specific and personalized to a relevant seller.

Personalization applications 2110 allow users of the networked system 102 to personalize various aspects of their interactions with the networked system 102. For example a user may, utilizing an appropriate personalization application 2110, create a personalized reference page at which information regarding transactions to which the user is (or has been) a party may be viewed. Further, a personalization application 2110 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 2112 that customize information (and/or the presentation of information) by the networked system 102 according to predetermined criteria (e.g., geographic, demographic or marketplace criteria). For example, the internationalization applications 2112 may be used to support the customization of information for a number of regional websites that are operated by the networked system 102 and that are accessible via respective web servers 116.

Navigation of the networked system 102 may be facilitated by one or more navigation applications 2114. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 2116 which users may utilize to upload images for inclusion within listings. An imaging application 2116 also operates to incorporate images within viewed listings. The imaging applications 2116 may also support one or more promotional features, such as image galleries that are presented to potential buyers. For example, sellers may pay an additional fee to have an image included within a gallery of images for promoted items.

Listing creation applications 2118 allow sellers to conveniently author listings pertaining to goods or services that they wish to advertise via the networked system 102, and listing management applications 2120 allow sellers to manage such listings. Specifically, where a particular seller has authored and/or published a large number of listings, the management of such listings may present a challenge. The listing management applications 2120 provide a number of features (e.g., auto-relisting, inventory level monitors, etc.) to assist the seller in managing such listings. One or more post-listing management applications 2122 also assist sellers with a number of activities that typically occur post-listing.

Dispute resolution applications 2124 provide mechanisms whereby disputes arising between transacting parties may be resolved. For example, the dispute resolution applications 2124 may provide guided procedures whereby the parties are guided through a number of operations in an attempt to settle a dispute. In the event that the dispute cannot be settled via the guided procedures, the dispute may be escalated to a third party mediator or arbitrator.

A number of fraud prevention applications 2126 implement fraud detection and prevention mechanisms to reduce the occurrence of fraud within the networked system 102.

Messaging applications 2128 are responsible for the generation and delivery of messages to users of the networked system 102, with such messages, for example, advising users regarding the status of listings at the networked system 102. Respective messaging applications 2128 may utilize any number of message delivery networks and platforms to deliver messages to users. For example, messaging applications 2128 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 2130 support various merchandising functions that are made available to sellers to enable sellers to increase sales via the networked system 102. The merchandising applications 2130 also operate the various merchandising features that may be invoked by sellers, and may monitor and track the success of merchandising strategies employed by sellers.

### Data Structures

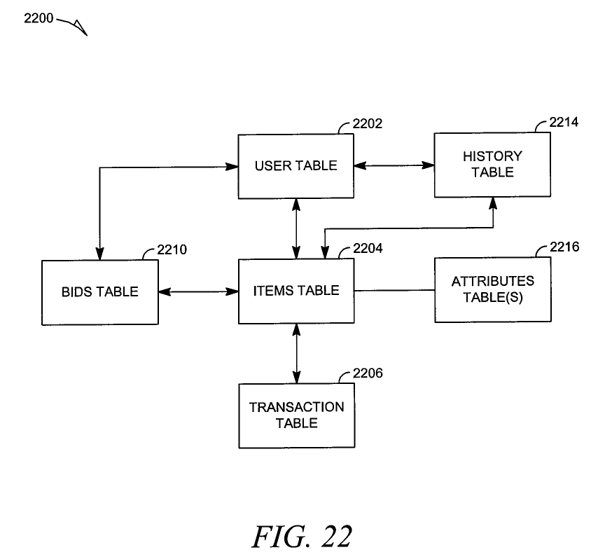

FIG. 22 is a high-level entity-relationship diagram, illustrating various tables 2200 that may be maintained within the databases 126 (FIG. 1), and that are utilized by and support the marketplace applications 120. A user table 2202 contains a record for each registered user of the networked system 102, and may include identifier, address and financial instrument information pertaining to each such registered user. A user may operate as a seller, a buyer, or both, within the networked system 102. Although it is to be appreciated that buyers need not be registered users in order to benefit from the payment service provided by the payment service application 128.

The tables 2200 also include an items table 2204 in which are maintained item records for goods and services that are available via the networked system 102. Each item record within the items table 2204 may furthermore be linked to one or more user records within the user table 2202, so as to associate a seller with each item record.

A transaction table 2206 contains a record for each transaction (e.g., a purchase or sale transaction) pertaining to items for which records exist within the items table 2204.

Bid records within a bids table 2210 each relate to a bid received at the networked system 102 in connection with an item listing. A history table 2214 maintains a history of transactions and/or item listings to which a user has been a party. One or more attributes tables 2216 record attribute information pertaining to items for which records exist within the items table 2204. Considering only a single example of such an attribute, the attributes tables 2216 may indicate a currency attribute associated with a particular item, the currency attribute identifying the currency of a price for the relevant item as specified in by a seller.

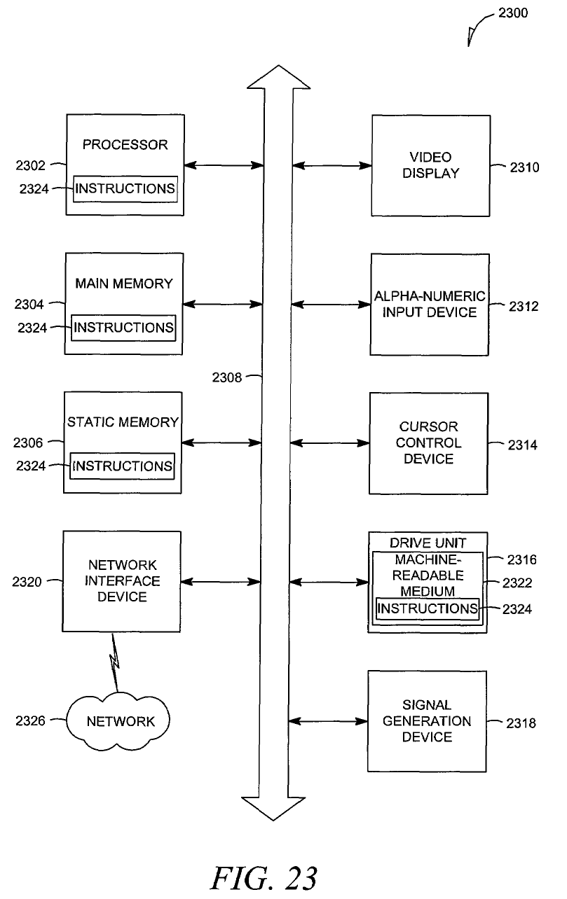

FIG. 23 shows a diagrammatic representation of machine in the example form of a computer system 2300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2300 includes a processor 2302 (e.g., a central processing unit (CPU) a graphics processing unit (GPU) or both), a main memory 2304 and a static memory 2306, which communicate with each other via a bus 2308. The computer system 2300 may further include a video display unit 2310 (e.g., a liquid crystal display (LCD) or a cathode ray tube (CRT)). The computer system 2300 also includes an alphanumeric input device 2312 (e.g., a keyboard), a cursor control device 2314 (e.g., a mouse), a disk drive unit 2316, a signal generation device 2318 (e.g., a speaker) and a network interface device 2320.

The disk drive unit 2316 includes a machine-readable medium 2322 on which is stored one or more sets of instructions (e.g., software 2324) embodying any one or more of the methodologies or functions described herein. The software 2324 may also reside, completely or at least partially, within the main memory 2304 and/or within the processor 2302 during execution thereof by the computer system 2300, the main memory 2304 and the processor 2302 also constituting machine-readable media.

The software 2324 may further be transmitted or received over a network 2326 via the network interface device 2320. While the machine-readable medium 2322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies. The term “machine-readable medium” shall accordingly be taken to include, but not be limited to, solid-state memories, optical and magnetic media, and carrier wave signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Thus, a method and system to facilitate payment in a network-based marketplace have been described. Although specific example embodiments have been described, it will be evident that various modifications and changes may be made to these embodiments. Accordingly, the specification and drawings are to be regarded in an illustrative rather than a restrictive sense.

The Abstract of the Disclosure is provided to comply with 37 C.F.R. §1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system which comprises:
one or more processors;
an item listing creator to create, using the one or more processors, an item listing on a market computer system, the item listing being in respect of an item which is offered for sale by a seller; and
a payment process module to facilitate, at the market computer system, payment between a buyer and the seller via an electronic payment service, the buyer being a non-registered user of the market computer system, the payment process model to facilitate the payment by use of the one or more processors.

2. The system of claim 1, wherein the payment process module is to facilitate payment by establishing a communication session between a buyer computer and a payment service server, financial obligations between the buyer and seller being established during the communication session.

3. The system of claim 2, wherein the payment process module is to provide a payment flow which comprises a series of linked operations, the establishing of the communication session between the buyer computer and the payment service server being integrated in the payment flow.

4. The system of claim 2, further comprising:
an invoice generator to generate an electronic invoice message which includes a payment link to establish the communication session between the buyer computer system and payment service server responsive to activation of the payment link on the buyer computer; and
a communication module to send the electronic invoice message to the buyer.

5. The system of claim 1, wherein the payment is subject to buyer protection provided by the electronic payment service.

6. The system of claim 5, wherein the buyer protection includes holding of the payment in escrow by the payment service subject to confirmation of receipt of the item by the buyer.

7. The system of claim 5, further comprising a risk evaluation module to evaluate a risk of payment associated with the item listing, and to adjust the buyer protection according to the evaluated risk.

8. The system of claim 1, wherein the item listing creator is to receive payment support input from the seller indicating that the item listing is to be supported by the electronic payment service, the facilitating of payment being conditional on the payment support input.

9. The system of claim 8, further comprising an item listing publication module to publish the item listing such that the item listing includes an indicator which identifies the item listing as being supported by the electronic payment service.

10. The system of claim 1, wherein the item listing creator is to receive payment support input from the buyer indicating that payment associated with the item listing is to be supported by the electronic payment service.

11. A method which comprises:
creating an item listing on a market computer system, the item listing being with respect to an item which is offered for sale by a seller; and
facilitating, at the market computer system, payment between a buyer and the seller via an electronic payment service, the buyer being a non-registered user of the market computer system.

12. The method of claim 11, wherein the facilitating of payment by the electronic payment service comprises establishing a communication session between a buyer computer and a payment service server, financial obligations between the buyer and seller being established during the communication session.

13. The method of claim 12, wherein the establishing of the communication session between the buyer computer and the payment service server is integrated in a payment flow managed by the market computer system, the payment flow comprising a series of linked operations managed by the market computer system.

14. The method of claim 12, wherein the facilitating of payment comprises:
generating an electronic invoice message which includes a payment link to establish the communication session between the buyer computer system and payment service server responsive to activation of the payment link on the buyer computer; and
sending the electronic invoice message to the buyer.

15. The method of claim 11, wherein the payment is subject to buyer protection provided by the electronic payment service.

16. The method of claim 15, wherein the buyer protection includes holding of the payment in escrow by the payment service subject to confirmation of receipt of the item by the buyer.

17. The method of claim 15, which further comprises evaluating a risk of payment associated with the item listing, and adjusting the buyer protection according to the evaluated risk.

18. The method of claim 11, wherein the creating of the item listing includes receiving payment support input from the seller indicating that the item listing is to be supported by the electronic payment service, the facilitating of payment being conditional on the payment support input.

19. The method of claim 18, further comprising displaying the item listing such that the item listing includes an indicator which identifies the item listing as being supported by the electronic payment service.

20. The method of claim 11, further comprising receiving payment support input from the buyer indicating that payment associated with the item listing is to be supported by the electronic payment service.

21. A system comprising:
means for creating an item listing on a market computer system, the item listing being in respect of an item which is offered for sale by a seller; and
means for facilitating, at the market computer system, payment between a buyer and the seller via an electronic payment service, the buyer being a non-registered user of the market computer system.

22. A non-tangible machine-readable medium storing instructions which, when performed by a machine, cause the machine to:
creating an item listing on a market computer system, the item listing being in respect of an item which is offered for sale by a seller; and
facilitating, at the market computer system, payment between a buyer and the seller via an electronic payment service, the buyer being a non-registered user of the market computer system.
